(19) United States
(12) Patent Application Publication
(10) Pub. No.: US 2023/0245152 A1
(43) Pub. Date: Aug. 3, 2023

(54) LOCAL TREND AND INFLUENCER IDENTIFICATION USING MACHINE LEARNING PREDICTIVE MODELS

(71) Applicant: Capital One Services, LLC, McLean, VA (US)

(72) Inventors: Xiaoguang ZHU, New York, NY (US); Kathryn TIKOIAN, Arlington, VA (US); Phoebe ATKINS, Rockville, VA (US)

(21) Appl. No.: 17/649,854

(22) Filed: Feb. 3, 2022

(51) Int. Cl. G06Q 30/02

(52) U.S. Cl. CPC G06Q 30/0205; G06Q 30/0201; G06N 20/00

(57) ABSTRACT

In some implementations, a trend prediction system may identify, using a machine learning model, one or more consumers having a historical tendency to adopt one or more trends near a beginning of one or more trend adoption curves. The trend prediction system may predict, using the machine learning model, a consumer trend near a beginning of a trend adoption curve based on a subset of consumer data associated with the one or more consumers having the historical tendency to adopt the trends near the beginning of the trend adoption curves. The trend prediction system may determine, based on the consumer trend that is near the beginning of the trend adoption curve, local trend information in an area associated with a client. The trend prediction system may provide, to a device associated with the client, the local trend information.

### BACKGROUND

Demand forecasting is a field in predictive analytics that is generally used to understand and/or predict consumer demand in order to optimize supply chain decisions. In some cases, demand forecasting may be performed using qualitative methods, which may be based on expert opinions and/or information gathered from the field. Additionally, or alternatively, demand forecasting may be performed using quantitative methods that use data (e.g., historical sales data) and/or statistical techniques from test markets (e.g., geographic regions or demographic groups that are used to gauge whether a product or a service is viable prior to a wide-scale rollout). Demand forecasting may be used to inform decision-making in various settings, including production planning, inventory management, assessing future capacity requirements, and/or deciding whether to enter a new market. Accurate demand forecasts are vital to manufacturers, distributors, retailers, and/or other entities in a supply chain to maintain optimized inventories (e.g., avoiding stock-outs and/or inventory obsolescence) and an efficient supply chain.

### SUMMARY

Some implementations described herein relate to a system for local trend and influencer identification. The system may include one or more memories and one or more processors communicatively coupled to the one or more memories. The one or more processors may be configured to obtain consumer data from one or more data sources, wherein the consumer data includes transaction data obtained from a transaction backend system, social media data obtained from one or more social media sites, and product-level data including stock keeping unit (SKU) information obtained from one or more consumer records or one or more merchant sites. The one or more processors may be configured to identify, using one or more machine learning models, one or more consumers having a historical tendency to adopt one or more trends near a beginning of one or more trend adoption curves associated with the one or more adopted trends. The one or more processors may be configured to predict, using the one or more machine learning models, a consumer trend that is near a beginning of a trend adoption curve associated with the consumer trend based on the transaction data, the social media data, and the SKU information included in the product-level data, wherein the consumer trend that is near the beginning of the trend adoption curve is identified based on a subset of the consumer data associated with the one or more consumers having the historical tendency to adopt the one or more trends near the beginning of the one or more trend adoption curves. The one or more processors may be configured to determine, based on the consumer trend that is near the beginning of the trend adoption curve, local trend information related to a forecasted demand for products or services associated with the consumer trend in an area associated with a client, wherein the local trend information is based on a correlation between the transaction data and one or more of the social media data or the SKU information included in the product-level data. The one or more processors may be configured to provide, to a device associated with the client, the local trend information.

Some implementations described herein relate to a method for local trend prediction. The method may include obtaining, by a trend prediction system, consumer data that includes transaction data obtained from a transaction backend system, social media data obtained from one or more social media sites, and product-level data including SKU information obtained from one or more consumer records or one or more merchant sites. The method may include identifying, by the trend prediction system, using a machine learning model, one or more consumers having a historical tendency to adopt one or more trends near a beginning of one or more trend adoption curves associated with the one or more adopted trends based on historical trend data related to historical consumer trends and historical consumer data related to adoption of the historical consumer trends by the one or more consumers. The method may include predicting, by the trend prediction system, using the machine learning model, a consumer trend that is near a beginning of a trend adoption curve based on a subset of the consumer data associated with the one or more consumers having the historical tendency to adopt the one or more trends near the beginning of the one or more trend adoption curves associated with the one or more adopted trends. The method may include generating, by the trend prediction system, local trend information that relates to a forecasted demand for products or services associated with the consumer trend based on adoption of the consumer trend in one or more geographic areas.

Some implementations described herein relate to a non-transitory computer-readable medium that stores a set of instructions for a trend prediction system. The set of instructions, when executed by one or more processors of the trend prediction system, may cause the trend prediction system to obtain consumer data from one or more data sources, wherein the consumer data includes transaction data obtained from a transaction backend system, social media data obtained from one or more social media sites, and product-level data including SKU information obtained from one or more consumer records or one or more merchant sites. The set of instructions, when executed by one or more processors of the trend prediction system, may cause the trend prediction system to predict, using one or more machine learning models, a consumer trend that is near a beginning of a trend adoption curve based on the transaction data, the social media data, and the SKU information included in the product-level data. The set of instructions, when executed by one or more processors of the trend prediction system, may cause the trend prediction system to determine, based on the consumer trend that is near the beginning of the trend adoption curve, local trend information related to a forecasted demand for products or services associated with the consumer trend in an area associated with a client. The set of instructions, when executed by one or more processors of the trend prediction system, may cause the trend prediction system to provide, to a device associated with the client, the local trend information.

### BRIEF DESCRIPTION OF THE DRAWINGS

FIGS. 1A-1C are diagrams of an example implementation relating to local trend and influencer identification using machine learning predictive models.

FIG. 2 is a diagram illustrating an example of training and using a machine learning model in connection with local trend and influencer identification.

FIG. 3 is a diagram of an example environment in which systems and/or methods described herein may be implemented.

FIG. 4 is a diagram of example components of one or more devices of FIG. 3.

FIG. 5 is a flowchart of an example process relating to local trend and influencer identification using machine learning predictive models.

### DETAILED DESCRIPTION

The following detailed description of example implementations refers to the accompanying drawings. The same reference numbers in different drawings may identify the same or similar elements.

In many industries (e.g., fashion, food, technology, interior design, marketing, and/or toys, among many other examples), trends in consumer behavior often change more rapidly than organizations have an ability to handle. For example, many organizations (e.g., retailers, restaurants, and/or building contractors, among other examples) may aim to be aware of current trends and/or prepared for trends that are emerging or will emerge in the future in order to be early adopters or innovators of new consumer trends. However, organizations may struggle to efficiently and/or accurately identify, anticipate, track, and/or react to changing consumer trends due to unreliable and/or inaccessible consumer trend data. Accordingly, trendspotting tools have become increasingly important as an intelligence tool to identify and track tendencies in consumer behavior and/or consumer interest. For example, trendspotting is generally a continuous cycle that begins with a consumer trend gaining in popularity, which may be followed by organizations adapting or pivoting inventories and/or marketing strategies to capitalize on the consumer trend before the consumer trend reaches a broader audience. Trendspotting has traditionally been performed using qualitative techniques, where certain personnel may comb through market research reports, attend trade shows, talk to customers, observe competitor activities, and/or and interact with recognized trendsetters or opinion leaders to discover new trends. However, qualitative techniques tend to be subjective and error-prone due to a heavy reliance on the acuity, judgment, and foresight of potentially fallible people. Moreover, many organizations (e.g., medium-sized or small businesses) may lack the resources to dedicate specific personnel to the task of identifying and interpreting consumer trends.

Furthermore, to the extent that trendspotting can also (or alternatively) be performed using quantitative techniques that rely on data analytics tools, quantitative trendspotting presents significant challenges due to the increasingly massive amounts of data that are available in the digital age. For example, data used in quantitative or analytics-based trendspotting often includes inaccuracies or noise that needs to be filtered out to uncover more reliable trend information and lower the risk of overreacting to idiosyncrasies in the data (e.g., making mistakes in inventory planning that are out-of-sync with consumer trends and habits, which may lead to supply shortages for emerging trends and/or obsolete inventories for outdated trends). Without a reliable mechanism to gather the correct indicators and/or interpret data to generate actionable intelligence regarding consumer trends, organizations may draw the wrong conclusions or misallocate potentially scarce resources. For example, to plan inventories, marketing strategies, and/or other customer-facing behavior based on current or anticipated consumer trends, organizations may need to distinguish fleeting trends (e.g., trends that experience a sharp increase in popularity before quickly fading away) from consolidative trends (e.g., trends that occur when smaller trends merge over time to create larger, wide-reaching trends that persist for a long time period) and/or macro or society-shaping trends (e.g., trends that span different demographics and/or geographies to eventually reflect genuine shifts in consumer behavior or interest over time). Accordingly, trendspotting tools that use quantitative data analytics techniques may face challenges with respect to deciding which trend data sources are valid (e.g., more likely to be accurate) and/or which trends identified by trusted data sources to prioritize. In particular, although there are large amounts of data available to trendspotting tools, the relevant data needs to be gathered and filtered in a regular and consistent manner with well-defined perspectives and frames of reference. Furthermore, once the data is gathered and appropriately filtered, the data needs to be evaluated and synthesized to create insight or meaning, such as providing a framework to determine which sources to trust, evaluating current trends or predicting emerging or future trends, and/or generating insights to inform decision-making to prioritize new or emerging trends and/or deprioritize outdated trends, among other examples.

Some implementations described herein relate to a trend prediction system that may obtain consumer data from various data sources and use machine learning techniques to identify consumer trends at a local level. For example, in some implementations, the trend prediction system may be associated with a financial institution, such as a bank or a credit card company, a transaction card association, and/or another suitable entity that has access to real-time transaction data. Accordingly, the consumer data obtained by the trend prediction system may generally include the real-time transaction data, which may include various attributes related to consumer purchasing behavior (e.g., dates, times, merchants, amounts, locations, and/or other information), and the real-time transaction data may be combined and/or correlated with other consumer data using machine learning techniques to identify consumer trends and/or trendsetters or trendspotters (e.g., consumers, social media personalities, and/or bloggers, among other examples) that tend to be innovators of new consumer trends and/or early adopters of new or emerging trends. For example, in some implementations, the real-time transaction data may be combined or correlated with consumer trend information obtained from scraping social media channels, performing natural language processing on market research reports, and/or identifying keywords or topics that are trending in web searches or other forums, among other examples. Additionally, or alternatively, the real-time transaction data may be combined or correlated with product-level data, such as stock keeping unit (SKU) data, which may indicate distinct products or services that are offered for sale, purchased, and/or tracked in inventories.

Accordingly, in some implementations, the trend prediction system may be configured to use one or more machine learning models to identify one or more consumers that tend to be innovators or early adopters of new trends for one or more product and/or service categories. Additionally, or alternatively, the trend prediction system may be configured to identify the consumers that tend to be innovators or early adopters at a hyperlocal level (e.g., within a small, geographically-defined area, such as a neighborhood, a community, a town, or a zip code). For example, in some implementations, the one or more machine learning models may be used to identify the innovators or early adopters, who may be collectively referred to herein as “influencers” or the like, based on historical trends and/or purchasing behavior represented in the real-time transaction data, the consumer trend information, and/or the product-level data. Additionally, or alternatively, the one or more machine learning models may be used to derive patterns relating to how the historical trends tended to cascade throughout a population over time. For example, the patterns may indicate whether a historical trend was fleeting, consolidative, and/or society-shaping, and/or may indicate how the historical trends cascaded from one geographic location to others (e.g., trends may typically, but not always, follow a pattern of emerging in one or a few major cities and later cascading to other cities and then more remote areas in a non-uniform manner). Accordingly, in some implementations, the trend prediction system may monitor the behaviors and/or purchasing patterns of the identified influencers to discover and/or characterize new or emerging trends, and the behaviors and/or purchasing patterns of the monitored influencers may be fed into the one or more machine learning models to validate whether and/or where the new or emerging trends appear on a trend adoption curve at a local level. In this way, the trend prediction system may generate trend information related to new, emerging, established, outdated, and/or future consumer trends based on real-time transaction data related to consumer purchasing behavior in combination with other relevant sources of trend information. Furthermore, in some implementations, the trend information may be provided to one or more clients or customers of the entity that has the access to the real-time transaction data, which may enable accurate demand forecasting, inventory planning to avoid stockouts or oversupplies, and/or improved communication with customers.

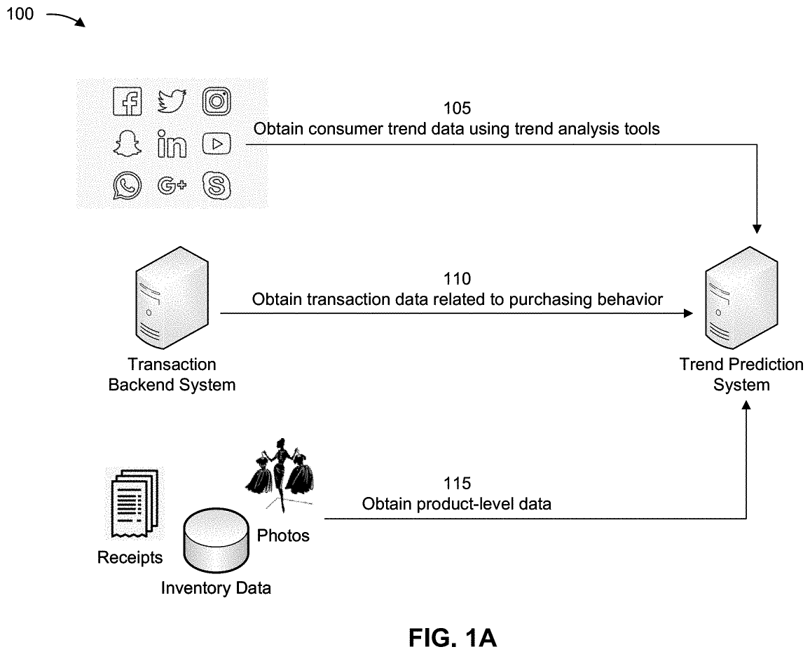

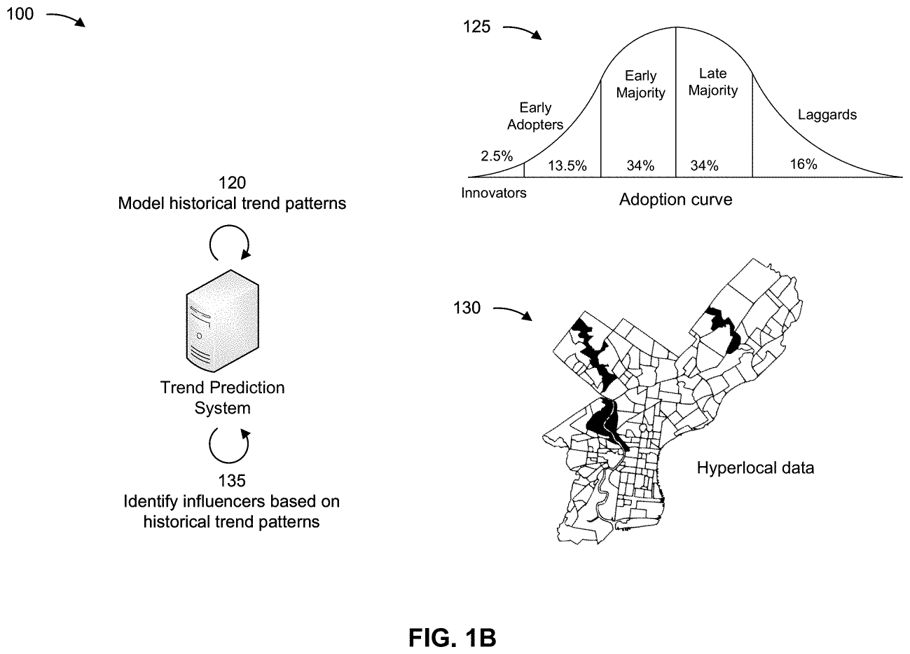

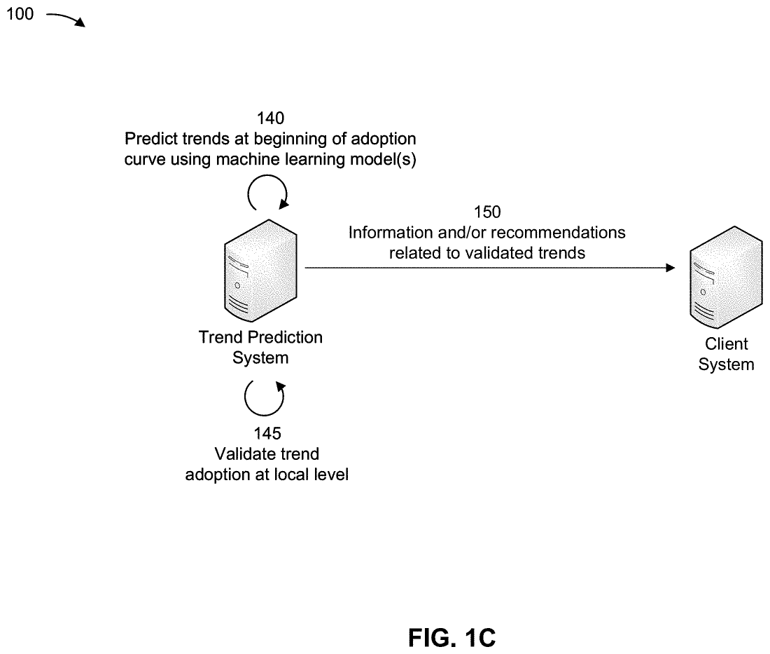

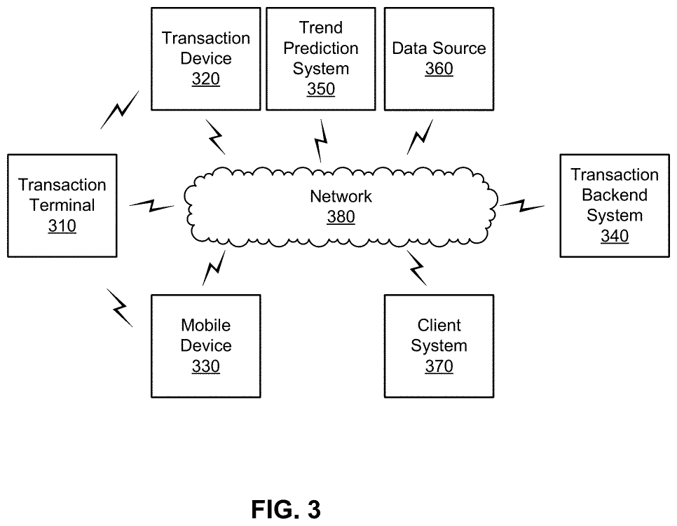

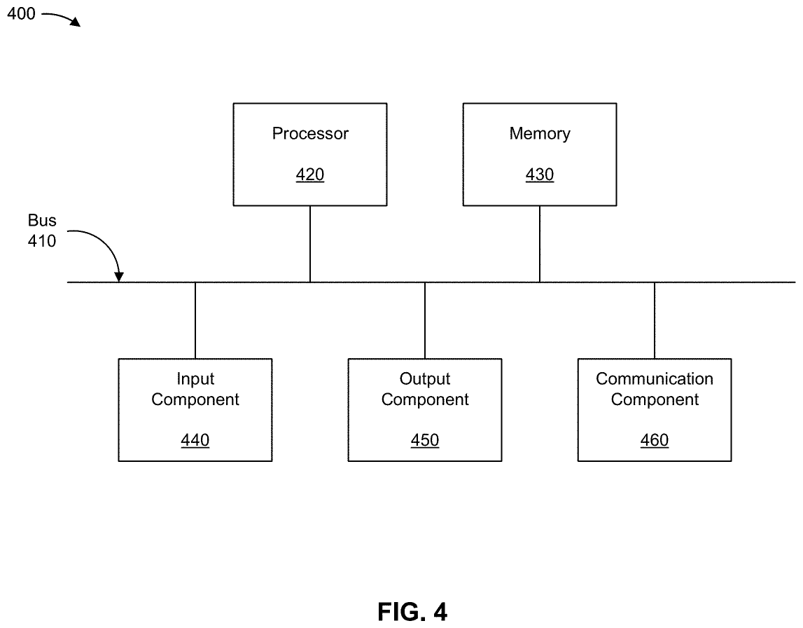

FIGS. 1A-1C are diagrams of an example 100 associated with local trend and influencer identification using machine learning predictive models. As shown in FIGS. 1A-1C, example 100 includes a trend prediction system, a transaction backend system, one or more data sources, and a client system. The trend prediction system, the transaction backend system, and the one or more data sources are described in more detail in connection with FIG. 3 and FIG. 4.

As shown in FIG. 1A, and by reference number 105, the trend prediction system may obtain consumer trend data using one or more trend analysis tools. For example, the trend prediction system may be configured to obtain the consumer trend data using one or more social listening tools, which may use web-scraping and/or other suitable techniques to extract consumer trend data from social media channels. For example, in some implementations, the social listening tool(s) may be configured to obtain data relating to trending topics, hashtags, keywords, styles, products, services, foods, lifestyles, and/or other information related to consumer behavior, preferences, and/or interests. The trend prediction system may be configured to obtain the consumer trend data from various data sources, which may include blogs, wikis, news sites, microblogs (e.g., Twitter), social networking sites, video and/or photo sharing websites, forums, message boards, and/or user-generated content, among other examples. Additionally, or alternatively, the trend prediction system may derive or otherwise obtain various data metrics related to the consumer trend data, such as time spent on a page, click-through rates, content shares, comments, and/or text analytics to identify positive and/or negative sentiments about consumer trends that may be represented in or otherwise identified from the consumer trend data. Furthermore, in many cases, the consumer trend data obtained using the social media listening tools may include location data (e.g., at-the-location data relating to content created at a specific location or about-the-location data relating to content that refers to a specific location) and/or content creation dates, which may be used as additional attributes to derive insights from the consumer trends that are represented in or otherwise identified from the consumer trend data.

In some implementations, in addition to obtaining the consumer trend data using the one or more social listening tools, the trend prediction system may obtain consumer trend data from other relevant data sources. For example, in some implementations, the trend prediction system may obtain consumer trend data from market research and/or consumer trend reports, keyword and/or search query analytics tools, consumer surveys, online media (e.g., interviews or podcasts including discussions with people who are influential or knowledgeable regarding trends in certain industries or market categories), and/or materials that are disseminated at trade shows or industry events, among other examples. In some implementations, the consumer trend data obtained from these and/or other data sources may be processed using natural language processing techniques, machine learning techniques, and/or other suitable techniques to obtain various attributes relating to historical consumer trends, current consumer trends, and/or consumer trends that are predicted to emerge in the future (e.g., in content created by or otherwise associated with individuals or entities with a proven and accurate track-record).

As further shown in FIG. 1A, and by reference number 110, the trend prediction system may be configured to obtain transaction data (e.g., in real-time) that relates to consumer purchasing behavior from a transaction backend system. For example, as described herein, the trend prediction system may be associated with a financial institution (e.g., a bank, a lender, a credit card company, or a credit union) and/or may be associated with a transaction card association that authorizes a transaction and/or facilitates a transfer of funds between different entities. Accordingly, the trend prediction system may have access to substantially real-time transaction data (e.g., credit card purchases) that relates to purchases made by consumers, where each transaction represented in the transaction data may be associated with one or more attributes that may be relevant to discovering historical, current, or future trends. For example, in some implementations, each transaction represented in the transaction data may be associated with a consumer or purchaser, a merchant or seller, an amount of the transaction, a product or service category (e.g., based on the merchant or seller), a date and/or time when the transaction occurred, and/or a location where the transaction occurred. Furthermore, in some implementations, the transaction data obtained by the trend prediction system may originate from one or more digital data sources, such as a peer-to-peer payment system (e.g., Venmo) that may include attributes such as locations, times, hashtags, emojis, comments, or other information relevant to transactions that may occur between friends and family or as an alternative to cash at vintage sales, farmers markets, and/or flea markets, among other examples. Accordingly, the transaction data obtained by the trend prediction system may include various attributes to provide detailed context related to historical sales activity and/or consumer purchasing behaviors, which may be combined or correlated with other data sources to model historical and/or current consumer trends and/or to validate consumer trends predicted to emerge in the future.

As further shown in FIG. 1A, and by reference number 115, the trend prediction system may obtain product-level data from various data sources, which may be combined or correlated with the consumer trend data and real-time transaction data obtained by the trend prediction system to identify trends in consumer products, behaviors, interests, communication methods, and/or preferences, among other examples. For example, in some implementations, the product-level information may include SKU information, where an SKU may generally refer to a distinct product or service that is purchased, offered for sale, or tracked in an inventory. For example, an SKU for a product may be associated with attributes such as a manufacturer, description, material, size, color, packaging, and/or warranty terms, among other examples, and an SKU for a service may be associated with other suitable attributes to distinctly identify the service being sold or offered for sale. Additionally, or alternatively, the product-level information may be represented using other suitable formats, such as a Global Trade Item Number (GTIN) (e.g., a Universal Product Code (UPC), an International Article Number (EAN), or another suitable standardized global tracking unit for products and/or services).

In some implementations, the product-level data may be obtained from sources of consumer records such as receipts that consumers scan and upload to the trend prediction system or another system accessible to the trend prediction system (e.g., a cloud storage service or a budgeting service) and/or email messages that include details related to individual products or services that are purchased in electronic transactions (e.g., where some users may authorize the trend prediction system to access and scan the users' email messages to obtain relevant product-level data). Accordingly, the consumer records may indicate specific products or services that consumers have purchased, which may be correlated with the real-time transaction data and/or the consumer trend data to provide further context for discovering and understanding historical trends, identifying current trends and/or predicting how the current trends are likely to cascade or otherwise progress in the future, and/or predicting future trends that have yet to emerge.

Additionally, or alternatively, the product-level data may be obtained from one or more merchant sites, such as SKU or GTIN metadata obtained from retailer or manufacturer sites, which may indicate items that the retailers or manufacturers include in their inventories. Additionally, or alternatively, the product-level data may be obtained from photographs, videos, or other media stored in cloud storage systems accessible to the trend prediction system and/or photographs, videos, or other media that may be posted on social media sites or other digital platforms. For example, in some implementations, the trend prediction system may use an image recognition or object recognition technology based on neural networks or other suitable techniques to identify specific products that are depicted in, visually similar to, or contextually relevant to products depicted in the photographs or other media. Accordingly, as described herein, the product-level data may be combined with the consumer trend data and/or the real-time transaction data, where the combined data may provide observations related to attributes of consumer behavior such as when and/or where certain products were purchased, offered for sale, and/or held in a merchant inventory.

As shown in FIG. 1B, and by reference number 120, the trend prediction system may model patterns in historical consumer trends (e.g., using one or more machine learning models) based on the consumer trend data, the real-time transaction data, and/or the product-level data. For example, as described herein, the trend prediction system may generate one or more datasets based on the consumer trend data, the real-time transaction data, and/or the product-level data, where the one or more datasets may include a training dataset, a test dataset, and/or a validation dataset that may be used to train one or more machine learning models to learn where, when, whether, and/or how consumer trends in different categories emerge and/or propagate throughout a society or culture over time. Accordingly, the one or more machine learning models may be trained based on one or more datasets that relate to historical consumer trends in different categories (e.g., fashion, food, accessories, gardening, lifestyle, consumer electronics, and/or toys, among other examples), with the consumer trend data, the real-time transaction data, and/or the product-level data including historical observations that relate to where, when, whether, and/or how certain historical consumer trends emerged and propagated or cascaded geographically and/or over time.

For example, reference number 125 illustrates an example of a trend adoption curve that shows how historical consumer trends may be modeled. In some implementations, the trend adoption curve may be based on a diffusion of innovations model that explains how, why, and at what rate the historical consumer trends spread throughout a society or culture. For example, the trend adoption curve may generally define successive groups of consumers adopting a new consumer trend, where an area under the trend adoption curve represents a market share of the new consumer trend. As further shown, the trend adoption curve may categorize consumers depending on the overall diffusion of the consumer trend at the time of adoption, where the categories of adopters may include innovators (e.g., defined as consumers that have a high social status and are willing to take risks to adopt trends that may ultimately fail), early adopters (e.g., defined as consumers that tend to have a highest degree of opinion leadership among the adopter categories and exhibit more judicious choices than innovators in determining which trends to adopt), early majority (e.g., defined as consumers that adopt an innovation after a varying degree of time that is significantly longer than innovators and early adopters, sometimes resulting in a “chasm” between the early adopters and the early majority), late majority (e.g., defined as consumers that adopt a trend after the average consumer, usually after the majority of a society has adopted the trend), and laggards (e.g., defined as consumers that are the last to adopt a trend and typically have an aversion to change). Furthermore, depending on the shape of the trend adoption curve associated with a specific consumer trend, the machine learning models may be trained to differentiate fleeting trends (or fads) from long-lasting or durable trends or other types of trends. For example, a fleeting trend may be associated with a trend adoption curve that is skewed to the left (e.g., where the early majority begins to adopt a trend soon after the early adopters and the popularity of the trend quickly fades away), whereas a durable trend may have a chasm between the early adopters and/or a low slope indicating a slow-moving but long-lasting change in consumer sentiment.

Furthermore, as shown by reference number 130, the machine learning models may be trained to model how trends propagate or cascade at a hyperlocal level using the consumer trend data, the real-time transaction data, and/or the product-level data. For example, in many industries, trends may have a tendency to originate in one area or a relatively small number of geographical areas (e.g., fashion trends first emerging in Los Angeles, New York, or Paris) before emerging in other metropolitan areas and then appearing in suburban or rural areas at a later time. However, in other industries, trends may have a tendency to propagate geographically in other ways (e.g., sustainable farming practices may originate in rural areas where farming innovations are more likely to occur before restaurants and/or grocers in urban areas start to offer sustainably farmed food to their customers). In other examples, trends may first emerge in one demographic profile before later propagating to other demographic profiles (e.g., a trend to engage in meme-based communication may first emerge in consumers with a younger demographic profile before later being adopted by older generations). In any case, the locations, demographic profiles, or other attributes related to where trends first emerge and/or how the trends cascade throughout a society or culture (e.g., geographically and/or demographically, among other examples) may be highly non-uniform and hyperlocal. For example, in some implementations, hyperlocal propagation or cascading patterns may depend on neighborhood or community-level variables such as population size, population densities, available shopping choices, cost of living, wages, terrain, demographics, proximity to larger markets, and/or other characteristics that may impact the behaviors, preferences, or interests of consumers that live in, work in, and/or visit a specific neighborhood or community. Accordingly, the trend prediction system may train the machine learning models to recognize patterns in historical current trends, including patterns in trend adoption curves that may be specific to certain categories or industries and/or specific to certain local or hyperlocal areas.

As further shown in FIG. 1B, and by reference number 135, the trend prediction system may identify one or more influencers (e.g., consumers that have a historical tendency to adopt consumer trends near the beginning of trend adoption curves) based on the historical trend patterns. For example, in some implementations, the trend prediction system may identify one or more consumers that were innovators or early adopters on a trend adoption curve associated with a historical consumer trend based on when the one or more consumers mentioned the historical consumer trend or engaged in other behavior related to the historical consumer trend on a social media channel or another digital platform and/or based on a purchase history indicating when the one or more consumers conducted a transaction to purchase a product or service related to the historical consumer trend, among other examples. Accordingly, based on the consumer trend data, the real-time transaction data, and/or the product-level data and the modeled patterns in historical trends, the trend prediction system may classify consumers into different categories (e.g., innovators, early adopters, early majority, late majority, and/or laggards, among other examples) that relate to when the consumers tend to adopt consumer trends along relevant trend adoption curves. Furthermore, in some implementations, the trend prediction system may classify consumers as a particular trend adopter type based on product or service categories to reflect variations in preferences or interests across different product or service categories (e.g., consumers that tend to be influencers in fashion categories such as clothing, jewelry, or accessories may be laggards or may not appear at all on a trend adoption curve associated with trends in products or services geared toward retiree lifestyle preferences). Additionally, or alternatively, the trend prediction system may use the purchase histories, product-level data, consumer trend data and/or other suitable data related to consumer behaviors to classify consumers into different trend adopter categories at a hyperlocal level. For example, a particular consumer living in a suburban region may have a tendency to adopt consumer trends in a particular category near the beginning of a trend adoption curve, which may indicate how consumer trends tend to propagate or cascade to that suburban region or other hyperlocal areas (e.g., a particular zip code, town, neighborhood, and/or community, among other examples).

As shown in FIG. 1C, and by reference number 140, the trend prediction system may predict one or more trends that are near a beginning of a trend adoption curve using the one or more machine learning models. For example, as described above, the one or more machine learning models may be trained (e.g., by the trend prediction system or another machine learning system) to recognize and understand patterns in historical consumer trends and/or to identify where different consumers (e.g., purchasers, social media personalities, and/or market analysts, among other examples) have a tendency to fall along a trend adoption curve associated with one or more product or service categories, locations, demographic profiles, and/or other parameters. In this way, the trend prediction system may monitor the purchasing behaviors, social media behaviors, and/or other consumer behaviors of certain consumers that tend to be innovators or early adopters in certain categories and/or locations to identify current trends and/or predict future trends that are near a beginning of a trend adoption curve. Additionally, or alternatively, the trend prediction system may place a heavier weight on monitoring the behaviors of consumers that tend to be early adopters based on innovators having a higher probability of adopting fleeting trends or fads that may not have a lasting societal impact. Accordingly, in some implementations, the trend prediction system may generally obtain the consumer trend data, the real-time transaction data, and the product-level data from various data sources as described in more detail above, which may be used as input to the one or more machine learning models to predict one or more trends that are near the beginning of a trend adoption curve in one or more categories (e.g., based on the modeled patterns in historical consumer trends and the historical consumer behaviors that occurred at different points on the trend adoption curve).

As further shown in FIG. 1C, and by reference number 145, the trend prediction system may validate, at a local level, adoption of the consumer trends that are predicted to be near the beginning of the trend adoption curve. For example, based on the trend prediction system identifying a current consumer trend that is in the innovators or early adopter phase of the trend adoption curve, the trend prediction system may validate whether and/or to what extent the current consumer trend is being adopted at a hyperlocal level (e.g., in certain communities or neighborhoods). For example, the trend prediction system may validate adoption of the current consumer trend based on social media posts that are tagged with location information (e.g., an at-the-location tag or an about-the-location tag), real-time transaction data that is tagged with location information (e.g., specific locations where the transactions are occurring), and/or product-level data that indicates SKUs or other product-specific information associated with the social media posts or real-time transactions, among other examples. In another examples, the trend prediction system may predict a cascading or propagation pattern for a current consumer trend, which may be used alone or in combination with other data inputs to validate whether the current consumer trend is being adopted at a local level, will soon cascade to certain areas, or is unlikely to cascade to certain areas, among other examples. In this way, the trend prediction system may determine local trend information in specific neighborhoods, communities, regions, or other geographical areas associated with one or more clients, such as retailers or manufacturers of consumer goods and/or organizations offering consumer services.

As further shown in FIG. 1C, and by reference number 150, the trend prediction system may provide local trend information and/or recommendations related to the local trend information to one or more client systems. For example, as described above, the trend prediction system may be associated with a financial institution and/or may be associated with a transaction card association that authorizes a transaction and/or facilitates a transfer of funds, and the local trend information and/or recommendations may be provided to client systems associated with certain customers of the financial institution and/or transaction card association (e.g., customers holding a small business credit card account). In some implementations, the local trend information and/or recommendations provided to the client system(s) may be specific to the emergence and/or propagation of historical, current, and/or future trends in a local area associated with the client system(s) and/or may include broader more general trend information. Additionally, or alternatively, the local trend information and/or recommendations may be specific to one or more product or service categories in which organizations associated with the client system(s) operate. For example, the local trend information and/or recommendations may be relevant to products or services included in inventories of the organizations associated with the client system(s) (e.g., recommending an inventory planning strategy to increase inventories or availabilities of products or services related to consumer trends that are expected to emerge in an area very soon and/or to wait to increase investment in products or services related to consumer trends that may be fleeting or not likely to cascade to an area for several months or years, among other examples). Furthermore, in some implementations, the trend prediction system may have access to the purchase histories of the organizations operating the client system(s), whereby the local trend information and/or recommendations may include recommendations to increase or decrease inventory levels for certain products or services to match a demand that is forecasted based on the local trend information.

As indicated above, FIGS. 1A-1C are provided as an example. Other examples may differ from what is described with regard to FIGS. 1A-1C.

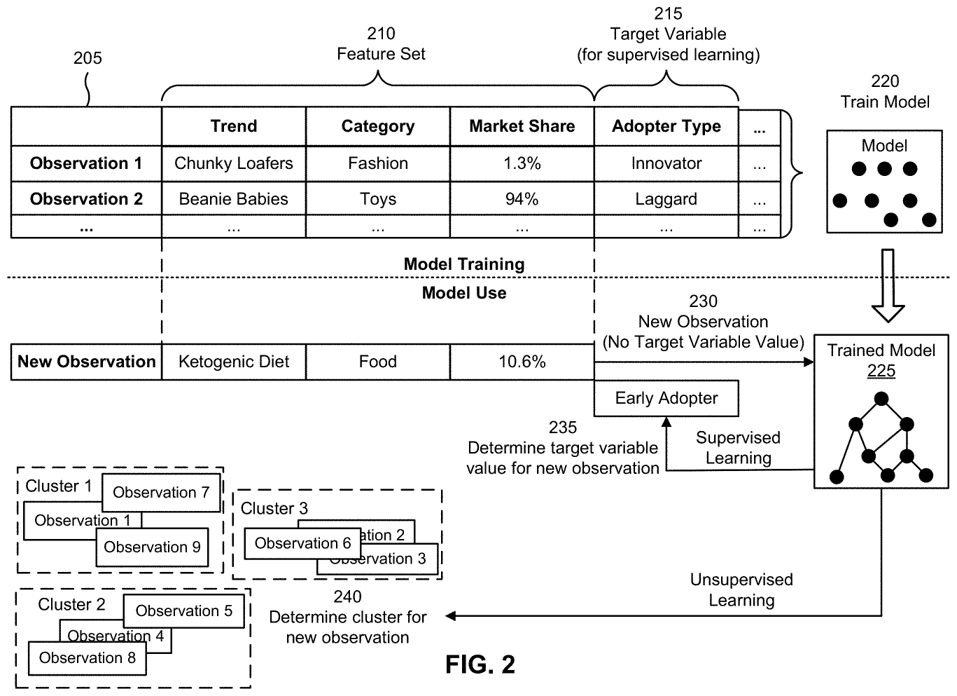

FIG. 2 is a diagram illustrating an example 200 of training and using a machine learning model in connection with local trend and influencer identification. The machine learning model training and usage described herein may be performed using a machine learning system. The machine learning system may include or may be included in a computing device, a server, a cloud computing environment, or the like, such as the trend prediction system described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from one or more data sources (e.g., a transaction backend system, social media sites, and/or other sources of qualitative or quantitative trend data), as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the one or more data sources. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of trend, a second feature of category, a third feature of market share, and so on. As shown, for a first observation, the first feature may have a value of “chunky loafers”, the second feature may have a value of “fashion”, the third feature may have a value of 1.3%, and so on. These features and feature values are provided as examples, and may differ in other examples. For example, the feature set may include one or more of the following features: coarse location, hyperlocation, purchase date, purchase amount, social media followers, social media mentions, and/or SKU, among other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is adopter type, which has a value of innovator for the first observation.

The feature set and target variable described above are provided as examples, and other examples may differ from what is described above. For example, for a target variable of trend cascading pattern, the feature set may include a trend, a trend category, a trend origination location, and/or time periods when the trend emerged in the trend origination location, in one or more other locations, and/or among consumers with different demographic profiles, among other examples.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of trend, a second feature of category, a third feature of market share, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, as shown by reference number 235, the trained machine learning model 225 may predict a value of early adopter for the target variable of adopter type for the new observation (e.g., the new observation may be a transaction to purchase a food item, a book, and/or another suitable product or service related to a ketogenic diet when the market share for products and services related to ketogenic diets was around 10.6%). Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, recommending that organizations in the food service industry offer menu items that are compatible with the ketogenic diet. The first automated action may include, for example, ordering books that relate to the ketogenic diet by a system that manages inventory for a bookstore and/or monitoring future purchase behavior, social behavior, or other behavior of the consumer classified as an early adopter to predict future trends in one or more food categories (e.g., groceries, restaurants, books, and/or fitness or nutrition services).

As another example, if the machine learning system were to predict a value of laggard for the target variable of adopter type, then the machine learning system may provide a second (e.g., different) recommendation (e.g., reduce an inventory level for books on the ketogenic diet or reduce the number of menu items that are tailored to the ketogenic diet) and/or may perform or cause performance of a second (e.g., different) automated action (e.g., reducing the sales price for books that relate to the ketogenic diet and/or deprioritize or lower the weight given to future purchase behavior, social behavior, or other behavior of the consumer classified as a laggard when predicting future trends in food categories.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., early adopter behavior), then the machine learning system may provide a first recommendation, such as the first recommendation described above. Additionally, or alternatively, the machine learning system may perform a first automated action and/or may cause a first automated action to be performed (e.g., by instructing another device to perform the automated action) based on classifying the new observation in the first cluster, such as the first automated action described above.

As another example, if the machine learning system were to classify the new observation in a second cluster (e.g., laggard behavior), then the machine learning system may provide a second (e.g., different) recommendation (e.g., the second recommendation(s) described above) and/or may perform or cause performance of a second (e.g., different) automated action (e.g., the second automated action(s) described above).

In some implementations, the recommendation and/or the automated action associated with the new observation may be based on a target variable value having a particular label (e.g., classification or categorization), may be based on whether a target variable value satisfies one or more thresholds (e.g., whether the target variable value is greater than a threshold, is less than a threshold, is equal to a threshold, falls within a range of threshold values, or the like), and/or may be based on a cluster in which the new observation is classified.

In this way, the machine learning system may apply a rigorous and automated process to identify consumers that tend to be innovators, early adopters, influencers, and/or potential trend spotters and/or to predict consumer trends that are near the beginning of a trend adoption curve, among other examples. The machine learning system enables recognition and/or identification of tens, hundreds, thousands, or millions of features and/or feature values for tens, hundreds, thousands, or millions of observations, thereby increasing accuracy and consistency and reducing delay associated with identifying consumers whose behavior is to be monitored to predict future consumer trends and/or predicting consumer trends at a local level to enable accurate demand forecasting relative to requiring computing resources to be allocated for tens, hundreds, or thousands of operators to manually identify trendy consumers and/or predict future consumer trends using the features or feature values.

As indicated above, FIG. 2 is provided as an example. Other examples may differ from what is described in connection with FIG. 2.

FIG. 3 is a diagram of an example environment 300 in which systems and/or methods described herein may be implemented. As shown in FIG. 3, environment 300 may include a transaction terminal 310, a transaction device 320, a mobile device 330, a transaction backend system 340, a trend prediction system 350, a data source 360, a client system 370, and/or a network 380. Devices of environment 300 may interconnect via wired connections and/or wireless connections.

The transaction terminal 310 includes one or more devices capable of facilitating an electronic transaction associated with the transaction device 320. For example, the transaction terminal 310 may include a point-of-sale (PoS) terminal, a payment terminal (e.g., a credit card terminal, a contactless payment terminal, a mobile credit card reader, or a chip reader), and/or an automated teller machine (ATM). The transaction terminal 310 may include one or more input components and/or one or more output components to facilitate obtaining data (e.g., account information) from the transaction device 320 and/or to facilitate interaction with and/or authorization from an owner or accountholder of the transaction device 320. Example input components of the transaction terminal 310 include a number keypad, a touchscreen, a magnetic stripe reader, a chip reader, and/or a radio frequency (RF) signal reader (e.g., a near-field communication (NFC) reader). Example output devices of transaction terminal 310 include a display and/or a speaker.

The transaction device 320 includes one or more devices capable of being used for an electronic transaction. In some implementations, the transaction device 320 includes a transaction card (or another physical medium with integrated circuitry) capable of storing and communicating account information, such as a credit card, a debit card, a gift card, an ATM card, a transit card, a fare card, and/or an access card. In some implementations, the transaction device 320 may be the mobile device 330 or may be integrated into the mobile device 330. For example, the mobile device 330 may execute an electronic payment application capable of performing functions of the transaction device 320 described herein. Thus, one or more operations described herein as being performed by the transaction device 320 may be performed by a transaction card, the mobile device 330, or a combination thereof.

The transaction device 320 may store account information associated with the transaction device 320, which may be used in connection with an electronic transaction facilitated by the transaction terminal 310. The account information may include, for example, an account identifier that identifies an account (e.g., a bank account or a credit account) associated with the transaction device 320 (e.g., an account number, a card number, a bank routing number, and/or a bank identifier), a cardholder identifier (e.g., identifying a name of a person, business, or entity associated with the account or the transaction device 320), expiration information (e.g., identifying an expiration month and/or an expiration year associated with the transaction device 320), and/or a credential (e.g., a payment token). In some implementations, the transaction device 320 may store the account information in tamper-resistant memory of the transaction device 320, such as in a secure element. As part of performing an electronic transaction, the transaction device 320 may transmit the account information to the transaction terminal 310 using a communication component, such as a magnetic stripe, an integrated circuit (IC) chip (e.g., a EUROPAY®, MASTERCARD®, VISA® (EMV) chip), and/or a contactless communication component (e.g., an NFC component, an RF component, a Bluetooth component, and/or a Bluetooth Low Energy (BLE) component). Thus, the transaction device 320 and the transaction terminal 310 may communicate with one another by coming into contact with one another (e.g., using a magnetic stripe or an EMV chip) or via contactless communication (e.g., using NFC).

The mobile device 330 includes one or more devices capable of being used for an electronic transaction, as described above in connection with the transaction device 320. The mobile device 330 may include a communication device and/or a computing device. For example, the mobile device 330 may include a wireless communication device, a mobile phone, a user equipment, a tablet computer, a wearable communication device (e.g., a smart wristwatch, a pair of smart eyeglasses, a head mounted display, or a virtual reality headset), or a similar type of device.

The transaction backend system 340 includes one or more devices capable of processing, authorizing, and/or facilitating a transaction. For example, the transaction backend system 340 may include one or more servers and/or computing hardware (e.g., in a cloud computing environment or separate from a cloud computing environment) configured to receive and/or store information associated with processing an electronic transaction. The transaction backend system 340 may process a transaction, such as to approve (e.g., permit, authorize, or the like) or decline (e.g., reject, deny, or the like) the transaction and/or to complete the transaction if the transaction is approved. The transaction backend system 340 may process the transaction based on information received from the transaction terminal 310, such as transaction data (e.g., information that identifies a transaction amount, a merchant, a time of a transaction, a location of the transaction, or the like), account information communicated to the transaction terminal 310 by the transaction device 320, and/or information stored by the transaction backend system 340 (e.g., for fraud detection).

The transaction backend system 340 may be associated with a financial institution (e.g., a bank, a lender, a credit card company, or a credit union) and/or may be associated with a transaction card association that authorizes a transaction and/or facilitates a transfer of funds. For example, the transaction backend system 340 may be associated with an issuing bank associated with the transaction device 320, an acquiring bank (or merchant bank) associated with the merchant and/or the transaction terminal 310, and/or a transaction card association (e.g., VISA® or MASTERCARD®) associated with the transaction device 320. Based on receiving information associated with the transaction device 320 from the transaction terminal 310, one or more devices of the transaction backend system 340 may communicate to authorize a transaction and/or to transfer funds from an account associated with the transaction device 320 to an account of an entity (e.g., a merchant) associated with the transaction terminal 310.

The trend prediction system 350 includes one or more devices capable of receiving, generating, storing, processing, providing, and/or routing information associated with local trends and/or trend influencers that may be identified using one or more machine learning predictive models, as described elsewhere herein. The trend prediction system 350 may include a communication device and/or a computing device. For example, the trend prediction system 350 may include a server, such as an application server, a client server, a web server, a database server, a host server, a proxy server, a virtual server (e.g., executing on computing hardware), or a server in a cloud computing system. In some implementations, the trend prediction system 350 includes computing hardware used in a cloud computing environment.

The data source 360 includes one or more devices capable of receiving, generating, storing, processing, and/or providing information associated with local trends and/or trend influencers that may be identified using one or more machine learning predictive models, as described elsewhere herein. The data source 360 may include a communication device and/or a computing device. For example, the data source 360 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 360 may communicate with one or more other devices of environment 300, as described elsewhere herein.

The client system 370 includes one or more devices capable of receiving, generating, storing, processing, providing, and/or routing information associated with local trends and/or trend influencers that may be identified using one or more machine learning predictive models, as described elsewhere herein. The client system 370 may include a communication device and/or a computing device. For example, the client system 370 may include a server, such as an application server, a client server, a web server, a database server, a host server, a proxy server, a virtual server (e.g., executing on computing hardware), or a server in a cloud computing system. In some implementations, the client system 370 includes computing hardware used in a cloud computing environment. Additionally, or alternatively, the client system 370 may include a client device or a user device, such as a wireless communication device, a mobile phone, a user equipment, a laptop computer, a tablet computer, a desktop computer, a wearable communication device (e.g., a smart wristwatch, smart eyeglasses, a head mounted display, or a virtual reality headset), or a similar device.

The network 380 includes one or more wired and/or wireless networks. For example, the network 380 may include a cellular network, a public land mobile network, a local area network, a wide area network, a metropolitan area network, a telephone network, a private network, the Internet, and/or a combination of these or other types of networks. The network 380 enables communication among the devices of environment 300. In some implementations, the transaction terminal 310 may communicate with the transaction device 320 using a first network (e.g., a contactless network or by coming into contact with the transaction device 320) and may communicate with the transaction backend system 340 using a second network.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to the transaction terminal 310, the transaction device 320, the mobile device 330, the transaction backend system 340, the trend prediction system 350, the data source 360, and/or the client system 370. In some implementations, the transaction terminal 310, the transaction device 320, the mobile device 330, the transaction backend system 340, the trend prediction system 350, the data source 360, and/or the client system 370 include one or more devices 400 and/or one or more components of device 400. As shown in FIG. 4, device 400 may include a bus 410, a processor 420, a memory 430, an input component 440, an output component 450, and a communication component 460.

Bus 410 includes one or more components that enable wired and/or wireless communication among the components of device 400. Bus 410 may couple together two or more components of FIG. 4, such as via operative coupling, communicative coupling, electronic coupling, and/or electric coupling. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform one or more operations or processes described elsewhere herein.

Memory 430 includes volatile and/or nonvolatile memory. For example, memory 430 may include random access memory (RAM), read only memory (ROM), a hard disk drive, and/or another type of memory (e.g., a flash memory, a magnetic memory, and/or an optical memory). Memory 430 may include internal memory (e.g., RAM, ROM, or a hard disk drive) and/or removable memory (e.g., removable via a universal serial bus connection). Memory 430 may be a non-transitory computer-readable medium. Memory 430 stores information, instructions, and/or software (e.g., one or more software applications) related to the operation of device 400. In some implementations, memory 430 includes one or more memories that are coupled to one or more processors (e.g., processor 420), such as via bus 410.

Input component 440 enables device 400 to receive input, such as user input and/or sensed input. For example, input component 440 may include a touch screen, a keyboard, a keypad, a mouse, a button, a microphone, a switch, a sensor, a global positioning system sensor, an accelerometer, a gyroscope, and/or an actuator. Output component 450 enables device 400 to provide output, such as via a display, a speaker, and/or a light-emitting diode. Communication component 460 enables device 400 to communicate with other devices via a wired connection and/or a wireless connection. For example, communication component 460 may include a receiver, a transmitter, a transceiver, a modem, a network interface card, and/or an antenna.

Device 400 may perform one or more operations or processes described herein. For example, a non-transitory computer-readable medium (e.g., memory 430) may store a set of instructions (e.g., one or more instructions or code) for execution by processor 420. Processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, processor 420 may be configured to perform one or more operations or processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

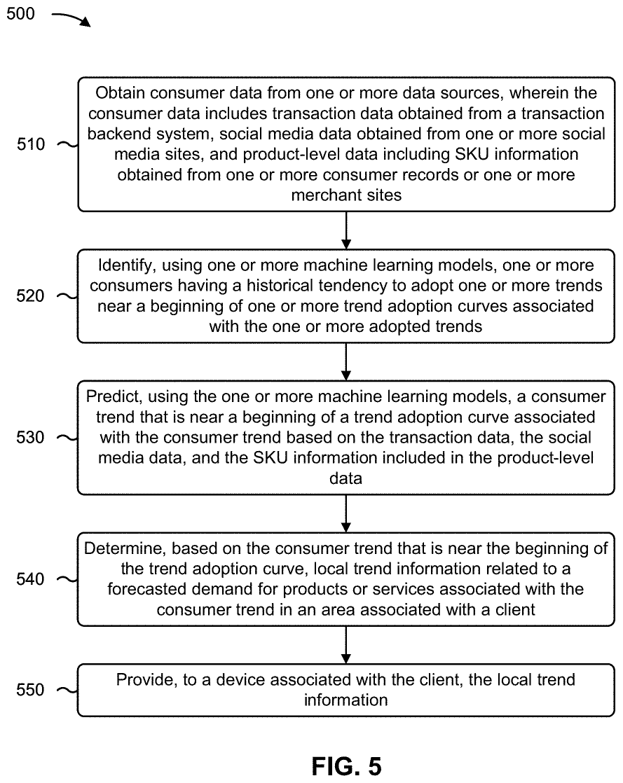

FIG. 5 is a flowchart of an example process 500 associated with local trend and influencer identification using machine learning predictive models. In some implementations, one or more process blocks of FIG. 5 may be performed by a trend prediction system (e.g., trend prediction system 350). In some implementations, one or more process blocks of FIG. 5 may be performed by another device or a group of devices separate from or including the trend prediction system, such as the transaction terminal 310, the transaction device 320, the mobile device 330, the transaction backend system 340, the data source 360, and/or the client system 370. Additionally, or alternatively, one or more process blocks of FIG. 5 may be performed by one or more components of device 400, such as processor 420, memory 430, input component 440, output component 450, and/or communication component 460.

As shown in FIG. 5, process 500 may include obtaining consumer data from one or more data sources (block 510). In some implementations, the consumer data includes transaction data obtained from a transaction backend system, social media data obtained from one or more social media sites, and product-level data including SKU information obtained from one or more consumer records or one or more merchant sites. As further shown in FIG. 5, process 500 may include identifying, using one or more machine learning models, one or more consumers having a historical tendency to adopt one or more trends near a beginning of one or more trend adoption curves associated with the one or more adopted trends (block 520). As further shown in FIG. 5, process 500 may include predicting, using the one or more machine learning models, a consumer trend that is near a beginning of a trend adoption curve associated with the consumer trend based on the transaction data, the social media data, and the SKU information included in the product-level data (block 530). In some implementations, the consumer trend that is near the beginning of the trend adoption curve is identified based on a subset of the consumer data associated with the one or more consumers having the historical tendency to adopt the one or more trends near the beginning of the one or more trend adoption curves. As further shown in FIG. 5, process 500 may include determining, based on the consumer trend that is near the beginning of the trend adoption curve, local trend information related to a forecasted demand for products or services associated with the consumer trend in an area associated with a client (block 540). For example, in some implementations, the local trend information is based on a correlation between the transaction data and one or more of the social media data or the SKU information included in the product-level data. As further shown in FIG. 5, process 500 may include providing, to a device associated with the client, the local trend information (block 550).

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for local trend and influencer identification, the system comprising:
one or more memories; and
one or more processors, communicatively coupled to the one or more memories, configured to:
obtain consumer data from one or more data sources,
wherein the consumer data includes transaction data obtained from a transaction backend system, social media data obtained from one or more social media sites, and product-level data including stock keeping unit (SKU) information obtained from one or more consumer records or one or more merchant sites;
identify, using one or more machine learning models, one or more consumers having a historical tendency to adopt one or more trends near a beginning of one or more trend adoption curves associated with the one or more adopted trends;
predict, using the one or more machine learning models, a consumer trend that is near a beginning of a trend adoption curve associated with the consumer trend based on the transaction data, the social media data, and the SKU information included in the product-level data,
wherein the consumer trend that is near the beginning of the trend adoption curve is identified based on a subset of the consumer data associated with the one or more consumers having the historical tendency to adopt the one or more trends near the beginning of the one or more trend adoption curves;
determine, based on the consumer trend that is near the beginning of the trend adoption curve, local trend information related to a forecasted demand for products or services associated with the consumer trend in an area associated with a client,
wherein the local trend information is based on a correlation between the transaction data and one or more of the social media data or the SKU information included in the product-level data; and
provide, to a device associated with the client, the local trend information.

2. The system of claim 1, wherein the local trend information is specific to a neighborhood or community in the area associated with the client.

3. The system of claim 1, wherein the one or more machine learning models classify the one or more consumers having the historical tendency to adopt the one or more trends near the beginning of the one or more trend adoption curves as innovators or early adopters.

4. The system of claim 1, wherein the local trend information provided to the device associated with the client indicates trends in one or more product categories that are relevant to an inventory associated with the client.

5. The system of claim 1, wherein the one or more processors are further configured to:
identify a subset of the consumer data that includes transaction data, social media data, or product-level data associated with the client; and
determine, based on the local trend information in the area associated with the client, potential gaps in an inventory associated with the client.

6. The system of claim 1, wherein the one or more processors are further configured to:
identify one or more product categories in which the one or more consumers have the historical tendency to adopt the one or more trends near the beginning of the one or more trend adoption curves; and
monitor the subset of the consumer data associated with the one or more consumers having the historical tendency to adopt the one or more trends near the beginning of the one or more trend adoption curves to detect consumer trends in the one or more product categories.

7. The system of claim 1, wherein the one or more consumers having the historical tendency to adopt the one or more trends near the beginning of the one or more trend adoption curves are identified based on historical trend data related to historical consumer trends and historical consumer data related to adoption of the historical consumer trends by the one or more consumers.

8. The system of claim 1, wherein the local trend information includes information related to adoption of the consumer trend that is near the beginning of the trend adoption curve in the area associated with the client.

9. A method for local trend prediction, comprising:
obtaining, by a trend prediction system, consumer data that includes transaction data obtained from a transaction backend system, social media data obtained from one or more social media sites, and product-level data including stock keeping unit (SKU) information obtained from one or more consumer records or one or more merchant sites;
identifying, by the trend prediction system, using a machine learning model, one or more consumers having a historical tendency to adopt one or more trends near a beginning of one or more trend adoption curves associated with the one or more adopted trends based on historical trend data related to historical consumer trends and historical consumer data related to adoption of the historical consumer trends by the one or more consumers;
predicting, by the trend prediction system, using the machine learning model, a consumer trend that is near a beginning of a trend adoption curve based on a subset of the consumer data associated with the one or more consumers having the historical tendency to adopt the one or more trends near the beginning of the one or more trend adoption curves associated with the one or more adopted trends; and
generating, by the trend prediction system, local trend information that relates to a forecasted demand for products or services associated with the consumer trend based on adoption of the consumer trend in one or more geographic areas.

10. The method of claim 9, wherein the local trend information relates to adoption of the consumer trend at a neighborhood or community level.

11. The method of claim 9, wherein the one or more machine learning models classify the one or more consumers having the historical tendency to adopt the one or more trends near the beginning of the one or more trend adoption curves as innovators or early adopters.

12. The method of claim 9, further comprising:
identifying one or more product categories in which the one or more consumers have the historical tendency to adopt the one or more trends near the beginning of the one or more trend adoption curves; and
monitoring the subset of the consumer data associated with the one or more consumers having the historical tendency to adopt the one or more trends near the beginning of the one or more trend adoption curves to detect consumer trends in the one or more product categories.

13. A non-transitory computer-readable medium storing a set of instructions, the set of instructions comprising:
one or more instructions that, when executed by one or more processors of a trend prediction system, cause the trend prediction system to:
obtain consumer data from one or more data sources,
wherein the consumer data includes transaction data obtained from a transaction backend system, social media data obtained from one or more social media sites, and product-level data including stock keeping unit (SKU) information obtained from one or more consumer records or one or more merchant sites;
predict, using one or more machine learning models, a consumer trend that is near a beginning of a trend adoption curve based on the transaction data, the social media data, and the SKU information included in the product-level data;
determine, based on the consumer trend that is near the beginning of the trend adoption curve, local trend information related to a forecasted demand for products or services associated with the consumer trend in an area associated with a client; and
provide, to a device associated with the client, the local trend information.

14. The non-transitory computer-readable medium of claim 13, wherein the consumer trend that is near the beginning of the trend adoption curve is identified based on a subset of the consumer data associated with the one or more consumers having a historical tendency to adopt one or more trends near a beginning of one or more trend adoption curves associated with the one or more adopted trends.

15. The non-transitory computer-readable medium of claim 14, wherein the one or more consumers having the historical tendency to adopt the one or more trends near the beginning of the one or more trend adoption curves are classified as innovators or early adopters.

16. The non-transitory computer-readable medium of claim 14, wherein the one or more instructions, when executed by the one or more processors of the trend prediction system, further cause the trend prediction system to:
identify one or more product categories in which the one or more consumers have the historical tendency to adopt the one or more trends near the beginning of the one or more trend adoption curves; and
monitor the subset of the consumer data associated with the one or more consumers having the historical tendency to adopt the one or more trends near the beginning of the one or more trend adoption curves to detect consumer trends in the one or more product categories.

17. The non-transitory computer-readable medium of claim 14, wherein the one or more consumers having the historical tendency to adopt the one or more trends near the beginning of the one or more trend adoption curves are identified based on historical trend data related to historical consumer trends and historical consumer data related to adoption of the historical consumer trends by the one or more consumers.

18. The non-transitory computer-readable medium of claim 13, wherein the local trend information provided to the device associated with the client indicates trends in one or more product categories that are relevant to an inventory associated with the client.

19. The non-transitory computer-readable medium of claim 13, wherein the one or more instructions further cause the trend prediction system to:
identify a subset of the consumer data that includes transaction data, social media data, or product-level data associated with the client; and
determine, based on the local trend information in the area associated with the client, potential gaps in an inventory associated with the client.

20. The non-transitory computer-readable medium of claim 13, wherein the local trend information includes information related to adoption of the consumer trend that is near the beginning of the trend adoption curve in the area associated with the client.
